(19) United States
(12) Patent Application Publication
(10) Pub. No.: US 2003/0129380 A1
(43) Pub. Date: Jul. 10, 2003

(54) Heat sensitive stencil sheet

(76) Inventors: Sayako Nakao, Ibaraki-ken (JP); Masahiro Matsuura, Ibaraki-ken (JP)

Correspondence Address: NATH & ASSOCIATES, 1030 15th STREET, 6TH FLOOR, WASHINGTON, DC, 20005, US

(21) Appl. No.: 10/320,511

(22) Filed: Dec. 17, 2002

(30) Foreign Application Priority Data
Dec. 18, 2001 (JP) P2001-384998
Dec. 16, 2002 (JP) P2002-364083

(51) Int. Cl. B32B 3/26

(52) U.S. Cl. 428/311.31

(57) ABSTRACT

A heat sensitive stencil sheet is provided that can provide a high-quality image, which is sharp and free from white spots and density inconsistencies even at high resolution. The heat sensitive stencil sheet comprises a thermoplastic resin film and an ink-permeable porous substrate, and the substrate has a minimum dispersion index of reflected light of 13 and a maximum total area percentage of high basis-weight areas and low basis-weight areas each having an area not less than 0.5 mm² of 3%, wherein with respect to a histogram of 64 levels of density of a reflected light image read on an area of (10 cm)² with a 787-by-787-pixel resolution, the dispersion index is defined as h/(L×100) wherein h represents a maximum peak frequency and L is (highest level which exceeds 500 frequencies)−(lowest level which exceeds 500 frequencies) +1; the high basis-weight areas are (level representing the maximum peak frequency +5 levels) or more; the low basis-weight areas are (level representing the maximum peak frequency−5 levels) or less; and the total area percentage (%) is {(total area of high basis-weight areas each having an area of not less than 0.5 mm²+ total area of low basis-weight areas each having an area of not less than 0.5 mm²)/(area of read image)}×100.

### BACKGROUND OF THE INVENTION

1. Field of the Invention

The present invention relates to a heat sensitive stencil sheet.

2. Description of the Related Art

Heretofore, as a heat sensitive stencil sheet (hereinafter simply referred to as “stencil sheet”), one having a structure in which a thermoplastic resin film such as a polyester film or a vinylidene chloride film and a porous substrate such as tissue paper, non-woven fabric or fabric composed essentially of natural fibers or synthetic fibers are laminated to each other via an adhesive is widely known (for example, refer to Japanese Patent Application Laid-Open Nos. 2512/1976 and 182495/1982).

To use these stencil sheets as plates, the thermoplastic film is perforated by a thermal head or by flash irradiation or infrared irradiation using such a light source as a halogen lamp, a xenon lamp or a flash lamp or by pulse irradiation of laser beam or other radiation. For example, a plate making method using the thermal head is a method comprising the steps of reading a source image by means of an image sensor, converting the read image into digital signals, sending the signals to the thermal head, and dot-perforating a thermoplastic film of a stencil sheet in the form of an image corresponding to the source image by means of heat generated from the thermal head so as to make a plate.

However, these stencil sheets are not necessarily satisfactory in terms of sharpness of a printed image. As one of its big factors, white missing portions and inconsistencies in density in the printed image can be named. This is because due to non-uniform ink permeability of the porous substrate, an amount of transferred ink varies from portion to portion, resulting in low sharpness of the image. To eliminate these white missing portions and inconsistencies in density, a method such as one which comprises increasing a printing pressure or decreasing the viscosity of ink so as to increase an amount of ink to be transferred is often used. In this case, while the white missing portions and the inconsistencies in density are eliminated since ink permeates through portions where the ink generally cannot permeate through easily, the amount of transferred ink also increases. As a result, there occur a problem that a printed image area is bled and print quality such as reproducibility of fine lines and fine letters is thereby lowered or a problem that ink failed to permeate and remaining on the surface of a paper smears an image area or makes contact with the back of next paper to be ejected and is transferred again to the paper. Particularly, when a proportion of printing in a printed image is large, in other words, when the image contains many solid areas, the above problems become conspicuous. Consequently, a middle ground between them must be found.

However, it is not easy to achieve balance of image sharpness by the foregoing middle ground, and a substantial improvement in sharpness of a printed image has been desired.

Further, in recent years, demand for high-resolution, high-image-quality thermal stencil printing capable of dealing with a variety of source documents including a document comprising fine letters and fine lines, a photograph, and a document having a large printed area such as white letters in a black background is on the increase.

For this reason, a thermal stencil printing machine has been undergoing such improvements as reducing the size of an element of a thermal head to a very small size so as to increase a dot density and reducing plate-making energy, and a highly sensitive heat sensitive stencil sheet which has properties adaptable to high resolution is demanded for use in the improved thermal stencil printing machine.

For these improvements, it has been proposed to define a weight ratio between a thin polyester fiber and a thick polyester fiber (refer to Japanese Patent Application Laid-Open No. 39429/1997), to define a pore area, deviation and rate of pore area of tissue paper (refer to Japanese Patent Application Laid-Open No. 39430/1997) or to define a state of dispersion of fibers by average transmittance of transmitted light and a formation index (refer to Japanese Patent Application Laid-Open No. 198557/1999). However, it has been found that even with these measures, satisfactory image sharpness cannot always be obtained.

It has been disclosed that one of leading causes of the above problem is that even if the sizes and dispersion of pores of the porous substrate are defined, these pores cannot be located. To improve print sharpness, it is necessary to make ink transfer uniformly by improving dispersibility of fibers constituting the porous substrate. However, with any of the prior arts, only the presence or absence of the pores of the substrate can be known. Further, it has also been found that since ink permeates through not only the pores but also mostly clearance between superimposed fibers, control of the pores alone does not necessarily improve the print sharpness.

Further, it has also been found that as resolution increases and perforated pore size are reduced, an amount of permeated ink per dot decreases, so that a difference in amount of permeated ink between where few or no fibers exist right under pores and where a number of fibers exist right under pores is large and print sharpness is impaired.

Thus, the present inventors have paid attention to the fact that it is fibers of the substrate which actually cause white missing portions and inconsistencies in density and have found that the white missing portions and inconsistencies in density can be eliminated, not by controlling the sizes or amount of pores through which ink permeates but by controlling dispersion of fibers constituting the substrate at any given site.

It is an object of the present invention to provide a heat sensitive stencil sheet which is free from the above problems of the conventional stencil sheets and can provide a high-quality image free from white missing portions and inconsistencies in density even at high resolution.

### SUMMARY OF THE INVENTION

That is, the present invention is directed to a heat sensitive stencil sheet which comprises a thermoplastic resin film and a porous substrate permitting ink permeability, wherein a dispersion index of reflected light obtained by irradiating the substrate with light is at least 13.

In the present stencil sheet, the dispersion index is defined as h/(L×100) wherein h represents a maximum peak frequency in a histogram obtained by classifying the density of a reflected light image read on an area of (10 cm)² with a 787-by-787-pixel resolution of 64 levels, and L is (highest level which exceeds 500 frequencies in the histogram)−(lowest level which exceeds 500 frequencies in the histogram) +1.

Further, the present invention is a heat sensitive stencil sheet which comprises a thermoplastic resin film and a porous substrate permitting ink permeability, wherein a total of area percentages of high basis-weight areas and low basis-weight areas each having an area not less than 0.5 mm² on the substrate is not higher than 3%, the high and low basis-weight areas being measured from reflected light obtained by irradiating the substrate with light.

In the present stencil sheet, with respect to a histogram obtained by classifying the density of a reflected light image read on an area of (10 cm)²with a 787-by-787-pixel resolution of 64 levels, the high basis-weight areas having a minimum density areas of (level representing a maximum peak frequency +5 levels), the low basis-weight areas having a maximum density areas of (level representing the maximum peak frequency−5 levels) and the total area percentage (%) of the high and low basis-weight areas each having an area not less than 0.5 mm² is {(total area of the high basis-weight areas each having an area not less than 0.5 mm²+total area of the low basis-weight areas each having an area not less than 0.5 mm²)/(area of the read image)}×100.

Further, the present invention is a heat sensitive stencil sheet which comprises a thermoplastic resin film and a porous substrate permitting ink permeability, wherein the substrate has a minimum dispersion index of reflected light obtained by irradiating with light of 13, and a total of area percentages of high basis-weight areas and low basis-weight areas each having an area not less than 0.5 mm² on the substrate is not higher than 3%.

In the present stencil sheet, with respect to a histogram obtained by classifying the density of a reflected light image read on an area of (10 cm)² with a 787-by-787-pixel resolution of 64 levels, the dispersion index is defined as h/(L×100) wherein h represents a maximum peak frequency in the histogram and L is (highest level which exceeds 500 frequencies in the histogram)−(lowest level which exceeds 500 frequencies in the histogram) +1. The high basis-weight areas having a minimum density areas of (level representing the maximum peak frequency +5 levels) in the histogram, the low basis-weight areas having a maximum density areas of (level representing the maximum peak frequency−5 levels ) in the histogram, and the total area percentage (%) of the high and low basis-weight areas each having an area not less than 0.5 mm² is {(total area of the high basis-weight areas each having an area not less than 0.5 mm²+total area of the low basis-weight areas each having an area not less than 0.5 mm²)/(area of the read image)}×100.

In particular, in the heat sensitive stencil sheets of the present invention, with respect to the above high basis-weight areas and low basis-weight areas, a total number of high basis-weight areas and low basis-weight areas each having an area not less than 1 mm² within an area of (10 cm)² on the porous substrate is preferably not more than 50, and a total number of high basis-weight areas and low basis-weight areas each having an area not less than 0.5 mm² but less than 1 mm² within an area of (10 cm)² on the porous substrate is preferably not more than 300.

### BRIEF DESCRIPTION OF THE DRAWINGS

FIG. 1A is a diagram for illustrating a method for determining a dispersion index from a histogram of density of an image on a porous substrate.

FIG. 1B is a diagram for illustrating a method for measuring high and low basis-weight areas from a histogram of density of an image on a porous substrate. (Wherein high basis-weight area hereinafter referred to as “flock”, low basis-weight area; hereinafter referred to as “LWA”.)

FIG. 2 is a diagram for illustrating an example of allocation of 21 gray scale levels of a test chart No. 6G of The Imaging Society of Japan to 256 gradation levels of a scanner.

“h” represents the height of a histogram (maximum peak frequency of the histogram), “L1” represents the lowest level which exceeds 500 frequencies, “L2” represents the highest level which exceeds 500 frequencies, “L” represents the width (L2 −L+1) of the histogram, “(i)” represents a threshold in measuring an LWA, and “(ii)” represents a threshold in measuring a flock.

### DETAILED DESCRIPTION OF THE PREFERRED EMBODIMENT

As a means for obtaining an amount of substrate fibers present at a given site, the present inventors have paid attention to information of reflected light obtained by irradiating the substrate with light. In the case of transmitted light, only the presence or absence of fibers can be known. However, in the case of reflected light, fibers reflect light while voids allow the light to pass therethrough. Further, an amount of reflected light is large in areas where the density of fibers is higher, while the amount of reflected light is small in areas where the density of fibers is lower. Thus, with reflected light, a state of dispersion of fibers can be known far more directly than with transmitted light.

By irradiating a substrate with light by use of a method in which fibers of the substrate are recognized as white portions and voids of the substrate are recognized as black portions, converting density distribution of reflected light into numerical values as dispersion indices of the fibers and providing for the numerical values, non-uniformity in existing amounts of the fibers can be eliminated and uniform ink permeability can be imparted to the substrate. The present inventors have found that print sharpness of a high-resolution image in particular can be thereby improved.

Further, when a substrate is irradiated with light in accordance with the above method, an area (high basis-weight area; “flock”) where the density of fibers is higher is recognized as a whiter area, and an area (low basis-weight area; “LWA”) where the density of fibers is lower is recognized as a blacker area. Of these flocks and LWAs, by controlling amounts of large flocks and LWAs which cause a difference in fiber density between given portions, ink permeability of the substrate can be uniform anywhere on the substrate. As a result of further study, it has been found that by providing for a percentage (area percentage) of areas occupied by flocks and LWAs larger than or equal to a certain size (area) with respect to a whole area and an existing amount (number) of the flocks and LWAs, in addition to the dispersion index, white missing portions and inconsistencies in density can be further eliminated in high-resolution printed images in particular.

In the present invention, a dispersion index and a total of area percentages of flocks and LWAs are measured based on the following definitions.

The dispersion index is defined as h/(L×100) wherein h represents a maximum peak frequency in a histogram obtained by classifying the density of a reflected light image read on an area of 10 cm×10 cm with a 787-by-787-pixel resolution of 64 levels, and L is (highest level which exceeds 500 frequencies in the histogram)−(lowest level which exceeds 500 frequencies in the histogram) +1.

Flocks have a minimum density areas of (level representing the maximum peak frequency +5 levels) in the above histogram, LWAs have a maximum density areas of (level representing the maximum peak frequency−5 levels) in the above histogram, and a total area percentage (%) of flocks and LWAs each having an area not less than 0.5 mm² is {(total area of the flocks each having an area of not less than 0.5 mm²+total area of the LWAs each having an area of not less than 0.5 mm²)/(area of the read image)}×100.

An example of measurements of the above dispersion index and the total of area percentages of flocks and LWAs will be described with reference to the drawings.

As a light source and a reflected light reading device, a flatbed scanner is used. To differentiate between voids and fibers in reading an image on a porous substrate (image from the porous substrate of a stencil sheet), black paper is lined to the back or film side of the porous substrate. The black paper to be lined preferably has a maximum average gray scale level of 5. Then, the density of reflected light is read in a resolution of 200×200 dpi on a 256- gradation level gray scale. According to the read image, the voids among the fibers of the porous substrate appear black, and the fibers of the porous substrate appear white. The more fibers converge or are superimposed on one another, the whiter they appear. Accordingly, with reflected light, information about a dispersion state of fibers which is closer to a state in actual printing can be obtained than with transmitted light.

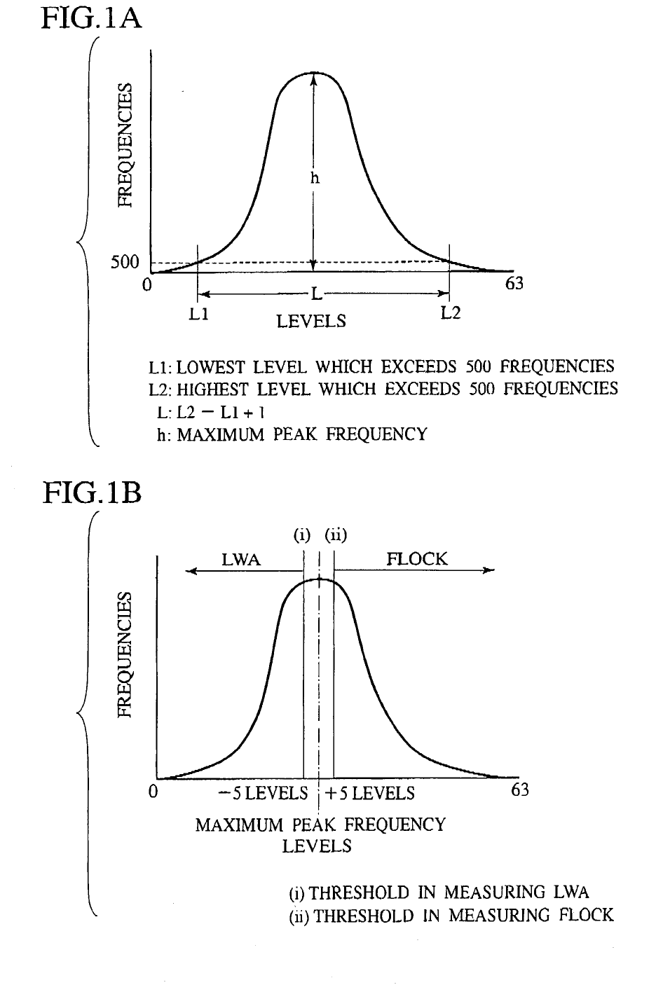

FIG. 1A is a diagram for illustrating a method for determining a dispersion index from a density histogram. To determine the dispersion index, firstly, a density histogram is prepared by image analysis of the image read above based on an area of 10 cm×10 cm (787×787 pixel, about 620,000 pixels in total) and classified into 64 levels. Levels at the feet of the histogram which do not exceed 500 frequencies are discarded, and the degree of sharpness of the remaining triangular histogram is expressed as the dispersion index.

Dispersion Index=h/(L×100)

h represents “maximum peak frequency in the histogram”, i.e., the height of the histogram, and L represents “(highest level which exceeds 500 frequencies)−(lowest level which exceeds 500 frequencies) +1, i.e., the width of the histogram. In FIG. 1A, L1 represents the lowest level which exceeds 500 frequencies, and L2 represents the highest level which exceeds 500 frequencies. The smallest value of the dispersion index is 1.5, and the largest value of the dispersion index is 6,200. The larger the dispersion index is, the sharper the histogram becomes, i.e., the closer a state of dispersion of fibers in a porous substrate gets to uniformity.

Further, FIG. 1B is a diagram for illustrating a method for measuring a flock and an LWA from a density histogram. Area percentages and numbers of flocks and LWAs are determined in the following manner. In the above density histogram classified into 64 levels, density areas of (level representing a maximum peak frequency ×5 levels) or more are defined as flocks and density areas of (level representing the maximum peak frequency−5 levels) or less are defined as LWAs so as to set thresholds, and flocks and LWAS were extracted based on the two thresholds. In FIG. 1B, (i) represents a threshold in measuring the LWAs, and (ii) represents a threshold in measuring the flocks. The sizes (areas) and numbers of the flocks and LWAs were measured, and a percentage of flocks or LWAs each having an area at least as large as a certain area (a) with respect to a whole measured area (area of 10 cm×10 cm) is expressed by the following expression as an area percentage of the flocks or LWAs each of which is at least as large as the above area. Area Percentage of Flocks or LWAs each having an area at least as large as an area (a) (%)=(Total Area of the Flocks or LWAs each having an area at least as large as the area (a))/(area of read image)×100

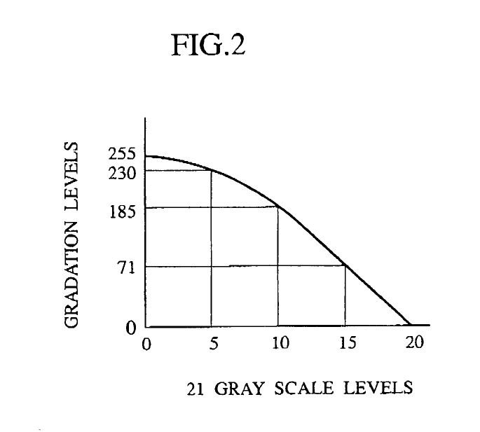

Further, to make brightness and contrast of an image uniform regardless of which flatbed scanner is used to read the image from a porous substrate, 256 gradation levels of a scanner can be allocated to gray scales of a test chart No. 6G of The Imaging Society of Japan as a reference, for example. Thereby, measurements can be made with good reproducibility by use of any flatbed scanner. FIG. 2 shows an example of allocation of 21 gray scale levels of the test chart No. 6G to 256 gradation levels of a scanner. A correspondence between them is shown in Table 1.

TABLE 1

| | Gradation Level |
|---|---|
| Scale Number of Test | Number of Read |
| Chart No. 6G | Image |
| 0 | 255 |
| 5 | 230 |
| 10 | 185 |
| 15 | 71 |
| 20 | 0 |

In the heat sensitive stencil sheet of the present invention, when the porous substrate has a dispersion index of less than 13, dispersion of fibers is not satisfactory, thereby resulting in an image with conspicuous white missing portions and inconsistencies in density disadvantageously. Meanwhile, when the dispersion index is at least 13, a sharp printed image free from inconsistencies in density and having almost inconspicuous white missing portions in solid areas can be obtained. Further, to attain high gradation reproducibility of fine letters, fine lines, photographs and the like, the dispersion index is preferably not less than 15, particularly preferably not less than 17. The larger the dispersion index is, the more preferable it is for a high-quality printed image.

In the case of the porous substrate in the present invention, when a total (hereinafter referred to as “total area percentage”) of an area percentage of flocks each having an area of not less than 0.5 mm² and an area percentage of LWAs each having an area of smaller than 0.5 mm² within an area of 10 cm×10 cm exceeds 3%, inconsistencies in density are noticeable in solid areas, and only an image with white missing portions can be obtained disadvantageously. The smaller the total area percentage is, the more preferable it is for a high-quality printed image. The total area percentage is preferably not more than 2%, is more preferably not more than 1%.

Further, from flocks and LWAs measured from the above density histogram, flocks and LWAs each having an area of not less than 1 mm² are detected. When a total of the numbers (hereinafter referred to as “total number”) of the flocks and LWAs each having an area of not less than 1 mm² is not more than 50, the numbers of sites where ink permeates very easily and sites where ink hardly permeates are smaller advantageously. The total number is more preferably 30 or less, much more preferably 10 or less.

In addition, when a total number of flocks and LWAs each having an area not less than 0.5 mm² but less than 1 mm² among the flocks and LWAs measured from the above density histogram is not more than 300, non-uniformity in dispersion of fibers in the porous substrate can be further suppressed advantageously. The total number is more preferably 200 or less, much more preferably 100 or less.

The porous substrate in the present invention has a dispersion index of reflected light and flocks and LWAs all of which fall within the above ranges and is not particularly limited as long as it is a porous substrate permitting printing ink permeability. The porous substrate comprises one or more of such fibers as a natural fiber, a synthetic fiber and a regenerated fiber and may have a structure of paper such as machined paper or tissue paper, a non-woven fabric or the like.

A method for producing the porous substrate is also not particularly limited. By increasing a basis weight or a proportion of fibers having small fiber diameters so as to increase the number of fibers per unit area, dispersibility can be improved.

In the case of paper, dispersibility can be improved by increasing the concentration of a thickener to be added to a paper material solution or adding a dispersion assistant so as to inhibit agglomeration of fibers, by reducing dewatering power after paper making so as to decrease a rate of formation of a paper layer or by lowering a pore ratio of a paper making wire. Further, the dispersibility can also be improved by lowering the concentration of paper stock in a stock inlet. In that case, the concentration of the paper material in the stock inlet is preferably not more than 0.5% by weight, more preferably not more than 0.1% by weight.

In general, it is believed that machine made paper can be prepared with a state of dispersion of fibers in a paper material solution retained by making a difference between wire speed and jet speed at the time of paper making as small as possible by use of an inclined short wire cloth paper machine. However, since machine made paper making requires a relatively high dehydration speed, the state of dispersion of the fibers does not improve from a certain point. Thus, paper having higher dispersibility can be obtained by intentionally enhancing orientation of an array of fibers in one direction, particularly in a longitudinal direction (carrying direction of a machine). In this case, although pore areas in between the fibers are increased since the fibers are oriented longitudinally, image sharpness improves since dispersibility improves. The degree of orientation of fibers can be known by measuring a ratio of tensile strengths in longitudinal and transverse (width) directions of paper (i.e., tensile strength in the transverse direction/tensile strength in the longitudinal direction; hereinafter referred to as “CM ratio”). The CM ratio is preferably not more than 0.40, more preferably not more than 0.35, particularly preferably not more than 0.30. As the paper machine, any paper machine such as an inclined short wire cloth paper machine or a cylinder paper machine can be used as long as it can enhance orientation of fibers in one direction as described above.

Of the fibers constituting the porous substrate, illustrative examples of the natural fiber include fibers from wood, cotton, paper mulberry, Mitsumata, Gampi, Manila hemp, flax, Sisal hemp, straw and bagasse. Of these, bast fibers such as paper mulberry, Mitsumata, Gampi and flax are excellent in print durability since they have high wet strength. Meanwhile, illustrative examples of the synthetic fiber or regenerated fiber include a polyester fiber, vinylon, an acrylic fiber, a polyethylene fiber, a polypropylene fiber, a polyamide fiber and rayon. Of these, the polyester fiber, vinylon and the acrylic fiber are preferred. They can be used alone or in combination of two or more. In the case of thin paper made by a wet process, a weight ratio of synthetic fibers based on the weight of natural fibers is preferably not less than 50% by weight, particularly preferably not less than 80% by weight. Further, the synthetic fibers contain synthetic fibers each having a fineness of not more than 0.2 denier in an amount of preferably 30% by weight, particularly preferably 40% by weight, based on a total weight of all fibers.

As the basis weight of the porous substrate, 5 to 20 g/m², particularly 9 to 13 g/m^{2,} is preferably used in view of image printability and stiffness. As the thickness of the porous substrate, 10 to 80 μm, particularly 35 to 50 μm, is preferably used. Further, as the density of the porous substrate, 0.15 to 0.40 kg/cm³, particularly 0.20 to 0.30 kg/cm³, is preferably used.

Illustrative examples of the thermoplastic resin film in the stencil sheet of the present invention include conventionally known films made of a polyester, a polyamide, a polyethylene, a polypropylene, a polyvinyl chloride, a polyvinylidene chloride, copolymers thereof and blends thereof. From the viewpoint of perforation sensitivity, a polyester, a copolymer thereof and a blend thereof are preferred.

Preferable examples of a polyester used in the thermoplastic resin film in the present invention include polyethylene terephthalate, polyethylene-2,6-naphthalate, polybutylene terephthalate, a copolymer of ethylene terephthalate and ethylene isophthalate, a copolymer of butylene terephthalate and ethylene terephthalate, a copolymer of butylene terephthalate and hexamethylene terephthalate, a copolymer of hexamethylene terephthalate and 1,4-cyclohexanedimethylene terephthalate, a copolymer of ethylene terephthalate and ethylene-2,6-naphthalate, and blends thereof.

The thermoplastic resin film is preferably stretched at least in a mono-axial direction. The thermoplastic resin film is more preferably a bi-axially stretched film. Further, the thickness of the thermoplastic resin film is preferably 0.1 to 5 μm. When the thickness is less than 0.1 μm, film-formation stability may deteriorate.

In the present invention, the thermoplastic resin film and the porous substrate may be laminated to each other by any lamination method which does not allow one of them to come off the other under normal conditions and does not inhibit perforation and permeation of ink.

When an adhesive is used, the adhesive may be a vinyl acetate-based adhesive, an acrylic adhesive, a vinyl chloride/vinyl-acetate-copolymer-based adhesive, a polyester-based adhesive or an urethane-based adhesive. The adhesive may also be an ultraviolet curing adhesive which is a compound of polyester acrylate, urethane acrylate, epoxy acrylate or polyol acrylate and a photopolymerization initiator. Particularly, an adhesive composed essentially of urethane acrylate is preferable. Further, the adhesive may contain other additives such as an antistatic agent and a lubricant as required.

In the heat sensitive stencil sheet of the present invention, a release agent is preferably coated on the surface of the thermoplastic resin film so as to prevent the stencil sheet from fusing into a thermal head or the like. As the release agent, one comprising a silicone oil, a silicone resin, a fluorocarbon resin, a surfactant or the like can be used. Upon application of a coating, the coating may contain not only the release agent but also a solvent such as water and a variety of additives such as a dispersion assistant and a surfactant which improve dispersibility of the release agent in a solvent, an antiseptic agent and an antifoaming agent, in such amounts that do not impair properties of the stencil sheet.

### EXAMPLES

Hereinafter, the present invention will be described in more detail with reference to Examples. However, the present invention shall not be limited thereto without departing from technical thoughts of the present invention. For example, the type of the thermoplastic resin film and the porous substrate may also be other than the type described herein. Further, “%” in Examples indicates “% by weight”, and measurements and evaluations of properties were made in accordance with the following methods.

Measurement of Dispersion Index

Black paper was placed on a film surface of a stencil sheet obtained in each of Examples and Comparative Examples to be described later, and by use of a flatbed scanner (scanner: ScanJet 4c manufactured by Hewlett-Packard Company, driver: DeskScan II manufactured by Hewlett-Packard Company) as a light source and a reflected light reading device, an image of reflected light of light irradiated against a porous substrate side of the stencil sheet was read on an area of 10 cm×10 cm with a resolution of 200×200 dpi on a 256- gradation level gray scale. Setting for reading was determined in accordance with the foregoing test chart No. 6G. Brightness was set at 150, and contrast was set at 170. A density histogram of the read image was detected by means of image software MacSCOPE (ver. 2.56). A dispersion index was determined by substituting the detected value into Dispersion Index =h/(L×100). The reading was conducted at five different sites on the same stencil sheet, and an average of the obtained dispersion indices was taken.

Measurements of Total Area Percentage and Total Numbers of Flocks and LWAs

Based on the density histogram of the image read above, (level representing a maximum peak frequency +5 levels) or more was defined as a flock and (level representing the maximum peak frequency−5 levels) or less was defined as an LWA so as to set thresholds, and flocks and LWAs were extracted. A total area percentage of flocks and LWAs each having an area of not less than 0.5 mm^{2,} a total number of flocks and LWAs each having an area of not less than 1 mm² in the foregoing area of 10 cm×10 cm on the porous substrate, and a total number of flocks and LWAs each having an area of not less than 0.5 mm² but less than 1 mm² in the foregoing area of 10 cm×10 cm were calculated. Further, the reading was conducted on five different sites on the same stencil sheet, and averages of the calculated total area percentages and total numbers were taken.

White Missing Portions and Inconsistencies in Density on Printed Image

In a stencil printing machine RISOGRAPH RP395 (trade name of product of RISO KAGAKU CORPORATION), a printing pressure and a printing speed were adjusted such that an amount of ink used to print B4-sized 200 papers each having an image proportion of 20% would be 15 g. By use of the printing machine and stencil sheets obtained in Examples and Comparative Examples to be described later, plate-making and printing of black solid areas, fine letters, fine lines and photographs were carried out, and inconsistencies in densities and white missing portions on the printed papers were visually evaluated based on the following criteria.

<White Missing Portion>⊚: No portions in fine letters and fine lines are missing, and no white missing portions are seen in black solid areas. ◯: Some portions in fine letters and fine lines are missing, but white missing portions in black solid areas are not conspicuous. Δ: Substantial portions in fine letters and fine lines are missing, and white missing portions in black solid areas are somewhat conspicuous. χ: A number of missing portions are seen in fine letters and fine lines, and a number of white missing portions are seen in black solid areas.

<Inconsistencies in Density>⊚: Density is uniform. ◯: Slight inconsistencies in density are seen, but the result indicates a usable level without any problem. Δ: Some inconsistencies in density are seen, but the result indicates a practically usable level. χ: Inconsistencies in density are conspicuous.

Gradation Reproducibility

Using the stencil sheets obtained in Examples and Comparative Examples, plate-making and printing of a document on which a dot density was continuously changed so as to impart gradation to the document were carried out in the same manner as the white missing portions and inconsistencies in density were evaluated, and gradation reproducibility of the printed papers was visually evaluated according to the following criteria. ⊚: All dots are reproduced without missing portions. ◯: Slight missing portions are seen in dots, but the result indicates a usable level without any problem. Δ: Some missing portions are seen in dots, but the result indicates a practically usable level. χ: Missing portions in dots are conspicuous, and gradation is not reproduced.

### Example 1

By use of an inclined short wire cloth paper machine, a paper material solution prepared by dispersing 35% of Manila hemp, 40% of PET fiber having a fineness of 0.1 denier and 25% of PET fiber having a fineness of 0.4 denier into water such that the concentration of the paper materials would be 0.07% was formed into a piece of tissue paper having a thickness of 47.3 μm, a basis weight of 12.5 g/m² and a CM ratio of 0.18. Then, a bi-axially oriented polyester film having a thickness of 1.7 μm was laminated on the tissue paper via a vinyl acetate resin, and a silicone-based release agent was then applied to the surface of the polyester film so as to prepare a heat sensitive stencil sheet.

### Example 2

By use of a cylinder paper machine, a paper material solution prepared by dispersing 40% of Manila hemp, 30% of PET fiber having a fineness of 0.1 denier and 30% of PET fiber having a fineness of 0.4 denier into water such that the concentration of the paper materials would be 0.15% was formed into a piece of tissue paper having a thickness of 40.6 μm, a basis weight of 10.7 g/m² and a CM ratio of 0.28. From the tissue paper, a heat sensitive stencil sheet was prepared in the same manner as in Example 1.

### Example 3

By use of an inclined short wire cloth paper machine, a paper material solution prepared by dispersing 50% of Manila hemp, 40% of PET fiber having a fineness of 0.1 denier and 10% of PET fiber having a fineness of 0.3 denier into water such that the concentration of the paper materials would be 0.25% was formed into a piece of tissue paper having a thickness of 48.2 μm, a basis weight of 12.4 g/m² and a CM ratio of 0.36. From the tissue paper, a heat sensitive stencil sheet was prepared in the same manner as in Example 1.

### Example 4

By use of an inclined short wire cloth paper machine, a paper material solution prepared by dispersing 45% of Manila hemp, 35% of PET fiber having a fineness of 0.1 denier and 20% of PET fiber having a fineness of 0.4 denier into water such that the concentration of the paper materials would be 0.3% was formed into a piece of tissue paper having a thickness of 49.2 μm, a basis weight of 12.8 g/m² and a CM ratio of 0.32. From the tissue paper, a heat sensitive stencil sheet was prepared in the same manner as in Example 1.

### Example 5

By use of an inclined short wire cloth paper machine, a paper material solution prepared by dispersing 65% of Manila hemp, 20% of PET fiber having a fineness of 0.1 denier and 15% of PET fiber having a fineness of 0.5 denier into water such that the concentration of the paper materials would be 0.30% was formed into a piece of tissue paper having a thickness of 42.0 μm, a basis weight of 11.5 g/m² and a CM ratio of 0.42. From the tissue paper, a heat sensitive stencil sheet was prepared in the same manner as in Example 1.

### Example 6

By use of an inclined short wire cloth paper machine, a paper material solution prepared by dispersing 55% of Manila hemp, 30% of PET fiber having a fineness of 0.3 denier and 15% of PET fiber having a fineness of 0.5 denier into water such that the concentration of the paper materials would be 0.40% was formed into a piece of tissue paper having a thickness of 45.0 μm, a basis weight of 10.9 g/m² and a CM ratio of 0.45. From the tissue paper, a heat sensitive stencil sheet was prepared in the same manner as in Example 1.

### Comparative Example 1

By use of a cylinder paper machine, a paper material solution prepared by dispersing 70% of Manila hemp, 15% of PET fiber having a fineness of 0.1 denier and 15% of PET fiber having a fineness of 0.4 denier into water such that the concentration of the paper materials would be 0.55% was formed into a piece of tissue paper having a thickness of 37.9 μm, a basis weight of 11.8 g/m² and a CM ratio of 0.38. From the tissue paper, a heat sensitive stencil sheet was prepared in the same manner as in Example 1.

### Comparative Example 2

By use of an inclined short wire cloth paper machine, a paper material solution prepared by dispersing 40% of Manila hemp, 20% of PET fiber having a fineness of 0.1 denier and 40% of vinylon fiber having a fineness of 0.4 denier into water such that the concentration of the paper materials would be 0.45% was formed into a piece of tissue paper having a thickness of 38.0 μm, a basis weight of 11.8 g/m² and a CM ratio of 0.53. From the tissue paper, a heat sensitive stencil sheet was prepared in the same manner as in Example 1.

### Comparative Example 3

By use of an inclined short wire cloth paper machine, a paper material solution prepared by dispersing 50% of Manila hemp, 10% of PET fiber having a fineness of 0.1 denier and 40% of PET fiber having a fineness of 0.3 denier into water such that the concentration of the paper materials would be 0.60% was formed into a piece of tissue paper having a thickness of 41.5 μm, a basis weight of 10.5 g/m² and a CM ratio of 0.55. From the tissue paper, a heat sensitive stencil sheet was prepared in the same manner as in Example 1.

### Comparative Example 4

By use of an inclined short wire cloth paper machine, a paper material solution prepared by dispersing 60% of Manila hemp, 10% of PET fiber having a fineness of 0.3 denier and 30% of PET fiber having a fineness of 0.5 denier into water such that the concentration of the paper materials would be 0.70% was formed into a piece of tissue paper having a thickness of 36.0 μm, a basis weight of 11.0 g/m² and a CM ratio of 0.40. From the tissue paper, a heat sensitive stencil sheet was prepared in the same manner as in Example 1.

### Comparative Example 5

By use of an inclined short wire cloth paper machine, a paper material solution prepared by dispersing 60% of Manila hemp, 20% of PET fiber having a fineness of 0.3 denier and 20% of PET fiber having a fineness of 0.5 denier into water such that the concentration of the paper materials would be 0.65% was formed into a piece of tissue paper having a thickness of 28.7 μm, a basis weight of 9.0 g/m² and a CM ratio of 0.62. From the tissue paper, a heat sensitive stencil sheet was prepared in the same manner as in Example 1.

The results of evaluations of the stencil sheet s of the foregoing Examples and Comparative Examples are shown in Table 2 and 3. Further, the results of evaluations of images printed on the stencil sheets are also shown in Table 2 and 3.

TABLE 2

| | Composition | | Basis | | |
|---|---|---|---|---|---|
| | of Fiber | Thickness | Weight | CM | Dispersion |
| Example | in Porous Substrate | (μm) | (g/m³) | Ratio | Index |
| Example 1 | Manila Hemp 35% | 47.3 | 12.5 | 0.18 | 18.3 |
| | 0.1d PET Fiber 40% | | | | |
| | 0.4d PET Fiber 25% | | | | |
| Example 2 | Manila Hemp 40% | 40.6 | 10.7 | 0.28 | 15.8 |
| | 0.1d PET Fiber 30% | | | | |
| | 0.4d PET Fiber 30% | | | | |
| Example 3 | Manila Hemp 50% | 48.2 | 12.4 | 0.36 | 13.2 |
| | 0.1d PET Fiber 40% | | | | |
| | 0.3d PET Fiber 10% | | | | |
| Example 4 | Manila Hemp 45% | 49.2 | 12.8 | 0.32 | 14.4 |
| | 0.1d PET Fiber 35% | | | | |
| | 0.4d PET Fiber 20% | | | | |
| Example 5 | Manila Hemp 65% | 42.0 | 11.5 | 0.42 | 13.4 |
| | 0.1d PET Fiber 20% | | | | |
| | 0.5d PET Fiber 15% | | | | |
| Example 6 | Manila Hemp 55% | 45.0 | 10.9 | 0.45 | 11.2 |
| | 0.3d PET Fiber 30% | | | | |
| | 0.5d PET Fiber 15% | | | | |
| Comparative | Manila Hemp 70% | 37.9 | 11.8 | 0.38 | 11.5 |
| Example 1 | 0.1d PET Fiber 15% | | | | |
| | 0.4d PET Fiber 15% | | | | |
| Comparative | Manila Hemp 40% | 38.0 | 11.8 | 0.53 | 8.9 |
| Example 2 | 0.1d PET Fiber 20% | | | | |
| | 0.4d Vinylon Fiber 40% | | | | |
| Comparative | Manila Hemp 50% | 41.5 | 10.5 | 0.55 | 9.5 |
| Example 3 | 0.1d PET Fiber 10% | | | | |
| | 0.3d PET Fiber 40% | | | | |
| Comparative | Manila Hemp 60% | 36.0 | 11.0 | 0.40 | 10.7 |
| Example 4 | 0.3d PET Fiber 10% | | | | |
| | 0.5d PET Fiber 30% | | | | |
| Comparative | Manila Hemp 60% | 28.7 | 9.0 | 0.62 | 9.0 |
| Example 5 | 0.3d PET Fiber 20% | | | | |
| | 0.5d PET Fiber 20% | | | | |

TABLE 3

| | Total of area | Total Number of Flocks | | | | |
|---|---|---|---|---|---|---|
| | percentage | and LWAs** | | Printed Image | | |
| | of flocks and | | Not less than | | Incon- | |
| | LWAs not | Not less | 0.5 mm² and | White | sistency | |
| | less than 0.5 | than | less than | missing | in | |
| | mm² (%)* | 1 mm² | 1 mm² | portion | density | Gradation |
| Example 1 | 0.8 | 8 | 70 | ⊚ | ⊚ | ⊚ |
| Example 2 | 1.7 | 23 | 116 | ⊚ | ⊚ | ∘ |
| Example 3 | 0.7 | 11 | 86 | ⊚ | ∘ | ∘ |
| Example 4 | 2.8 | 54 | 235 | ∘ | ∘ | ∘ |
| Example 5 | 4.9 | 80 | 350 | ∘ | ∘ | Δ |
| Example 6 | 2.5 | 40 | 320 | ∘ | Δ | Δ |
| Comparative | 6.7 | 75 | 380 | Δ | x | x |
| Example 1 | | | | | | |
| Comparative | 13.7 | 250 | 580 | x | x | x |
| Example 2 | | | | | | |
| Comparative | 10.4 | 320 | 614 | x | x | x |
| Example 3 | | | | | | |
| Comparative | 9.5 | 180 | 487 | Δ | x | x |
| Example 4 | | | | | | |
| Comparative | 18.2 | 407 | 853 | x | x | x |
| Example 5 | 18.2 | 407 | 853 | x | x | x |

*Total of area percentage of flocks and LWAs each having an area not less than 0.5 mm² (%)
**Number within an area of 10 cm × 10 cm on a substrate.

Since the stencil sheets obtained in Examples 1 to 6 were so controlled as to have high dispersion indices, low total area percentages of flocks and LWAs and small total numbers of the flocks and LWAs, they showed good fiber dispersibility, uniform ink transferability and good printed image reproducibility. In particular, due to the high dispersion index, Example 1 was free from inconsistencies in density even with respect to a paper having a number of solid areas, and a high-quality image with good gradation reproducibility was obtained with respect to a source photograph. As for the stencil sheets obtained in Comparative Examples 1 to 5, non-uniform fiber dispersibility was seen, and ruptures in letters and fine lines, white missing portions within solid areas, inconsistencies in density and poor gradation reproducibility were noticeable in the printed images.

According to the present invention, non-uniformity in dispersion of fibers constituting a porous substrate of a heat sensitive stencil sheet is eliminated. Thereby, a heat sensitive stencil sheet that has uniform ink transferability and can provide a high-quality printed image with excellent gradation reproducibility which is free from white missing portions and inconsistencies in density even at high resolution.

What is claimed is:

1. A heat sensitive stencil sheet which comprises a thermoplastic resin film and a porous substrate permitting ink permeability, wherein a dispersion index of reflected light obtained by irradiating the substrate with light is at least 13, the dispersion index being defined as h/(L×100) wherein h represents a maximum peak frequency in a histogram obtained by classifying the density of a reflected light image read on an area of (10 cm)² with a 787-by-787-pixel resolution of 64 levels, and L is (highest level which exceeds 500 frequencies in the histogram)−(lowest level which exceeds 500 frequencies in the histogram) +1.

2. A heat sensitive stencil sheet which comprises a thermoplastic resin film and a porous substrate permitting ink permeability, wherein a total of area percentages of high basis-weight areas and low basis-weight areas each having an area not less than 0.5 mm² on the substrate is not higher than 3%,
the high and low basis-weight areas being measured from reflected light obtained by irradiating the substrate with light,
provided that with respect to a histogram obtained by classifying the density of a reflected light image read on an area of (10 cm)²with a 787-by-787-pixel resolution of 64 levels,
the high basis-weight areas having a minimum density areas of (level representing a maximum peak frequency +5 levels),
the low basis-weight areas having a maximum density areas of (level representing the maximum peak frequency−5 levels),
and the total area percentage (%) of the high and low basis-weight areas each having an area not less than 0.5 mm² is ((total area of the high basis-weight areas each having an area not less than 0.5 mm²+total area of the low basis-weight areas each having an area not less than 0.5 mm²)/(area of the read image)) ×100.

3. A heat sensitive stencil sheet which comprises a thermoplastic resin film and a porous substrate permitting ink permeability,
wherein the substrate has a minimum dispersion index of reflected light obtained by irradiating with light of 13,
and a total of area percentages of high basis-weight areas and low basis-weight areas each having an area not less than 0.5 MM2 on the substrate is not higher than 3%,
provided that with respect to a histogram obtained by classifying the density of a reflected light image read on an area of (10 cm)² with a 787-by-787-pixel resolution of 64 levels,
the dispersion index is defined as h/(L×100) wherein h represents a maximum peak frequency in the histogram and L is (highest level which exceeds 500 frequencies in the histogram)−(lowest level which exceeds 500 frequencies in the histogram) +1, the high basis-weight areas having a minimum density areas of (level representing the maximum peak frequency +5 levels), the low basis-weight areas having a maximum density areas of (level representing the maximum peak frequency−5 levels ), and the total area percentage (%) of the high and low basis-weight areas each having an area not less than 0.5 mm² is {(total area of the high basis-weight areas each having an area not less than 0.5 mm² +total area of the low basis-weight areas each having an area not less than 0.5 mm²)/(area of the read image)}×100.

4. The heat sensitive stencil sheet of any of 20 claims 1 to 3, wherein a total number of high basis-weight areas and low basis-weight areas each having an area not less than 1 mm² within an area of (10 cm)² on the porous substrate is not more than 50, provided that the high basis-weight areas have a minimum density areas of (level representing a maximum peak frequency +5 levels) in a histogram obtained by classifying the density of a reflected light image read on the area of (10 cm)² with a 787-by-787-pixel resolution of 64 levels, and the low basis-weight areas have a maximum density areas of (level representing the maximum peak frequency−5 levels) in the histogram.

5. The heat sensitive stencil sheet of any of claims 1 to 3, wherein a total number of high basis-weight areas and low basis-weight areas each having an area not less than 0.5 mm² but less than 1 mm² within an area of (10 cm)² on the porous substrate is not more than 300, provided that the high basis-weight areas have a minimum density areas of (level representing a maximum peak frequency +5 levels) in a histogram obtained by classifying the density of a reflected light image read on the area of (10 cm)² with a 787-by-787-pixel resolution of 64 levels, and the low basis-weight areas have a maximum density areas of (level representing the maximum peak frequency−5 levels) in the histogram.

6. The heat sensitive stencil sheet of claim 4, wherein a total number of high basis-weight areas and low basis-weight areas each having an area not less than 0.5 mm² but less than 1 mm² within an area of (10 cm)² on the porous substrate is not more than 300, provided that the high basis-weight areas have a minimum density areas of (level representing a maximum peak frequency +5 levels) in a histogram obtained by classifying the density of a reflected light image read on the area of (10 Cm)² with a 787-by-787-pixel resolution of 64 levels, and the low basis-weight areas have a maximum density areas of (level representing the maximum peak frequency−5 levels) in the histogram.
